(19) United States
(12) Patent Application Publication
(10) Pub. No.: US 2025/0198235 A1
(43) Pub. Date: Jun. 19, 2025

(54) RETRACTABLE ROLLER FOR LADDERS

(71) Applicant: LITTLE GIANT LADDER SYSTEMS, LLC, Springville, UT (US)

(72) Inventors: Aaron Bruce MAJOR, Nephi, UT (US); N. Ryan MOSS, Mapleton, UT (US); B. Scott MAXFIELD, Mapleton, UT (US); Brian B. RUSSELL, Saratoga Springs, UT (US); Tallon C. BECKSTROM, Spanish Fork, UT (US)

(21) Appl. No.: 18/979,089

(22) Filed: Dec. 12, 2024

Related U.S. Application Data
(60) Provisional application No. 63/611,043, filed on Dec. 15, 2023.

(51) Int. Cl. E06C 1/397; E06C 1/06; E06C 1/18; E06C 7/42

(52) U.S. Cl. CPC E06C 1/397; E06C 1/06; E06C 1/18; E06C 7/42

(57) ABSTRACT

Ladders, ladder feet, and roller assemblies can include a roller attached to a foot and extendable below a bottom surface of the foot to allow the ladder or foot to roll on a ground surface. the roller may be retractable in response to a downward force being applied to the foot, thereby allowing the bottom surface to contact the ground surface and support the ladder or foot. The roller can be biased back to the extended position when the downward force is removed. A lock member, such as a rotatable arm, can be used to lock the roller in a retracted state.

### CROSS-REFERENCE TO RELATED APPLICATIONS

This application claims the benefit of U.S. Provisional Application No. 63/611,043, filed 15 Dec. 2023, entitled RETRACTABLE ROLLER FOR LADDERS, the disclosures of which are incorporated by reference herein in its entirety.

### TECHNICAL FIELD

The present disclosure generally relates to rollers for ladders and particularly relates to retractable rollers to assist in moving the ladder.

### BACKGROUND

Ladders are an essential tool for enabling workers to reach difficult areas, but they can be difficult and cumbersome to move from place to place. Their length and weight can be tiresome to lift, especially when the ladder needs to be moved many times over the course of a day. Some ladders include wheels to help the user roll the ladder rather than having to carry the ladder, but the wheels often still require the user to reconfigure the ladder, such as by deploying and stowing the wheels for each use, or by requiring the user to tilt and turn the ladder into unusual angles for the wheels to support the ladder. Thus, even ladders with wheels can be cumbersome to move. For these and other reasons, there is a constant need for improvements to ladders and transportation of other large and tall objects.

### SUMMARY

One aspect of the present disclosure relates to a ladder including a pair of rails spaced apart from each other, a set of rungs coupled to and extending between the pair of rails, a roller assembly, and a lock member. The roller assembly includes a carriage slidable relative to a rail of the pair of rails and a roller rotatably coupled to and movable with the carriage relative to the rail. The roller assembly is movable relative to the rail between a first position and a second position. In the first position, the roller extends below a bottom end of the rail. In the second position, the roller is retracted relative to the first position. The roller assembly is movable, in response to application of a downward force to a rung of the set of rungs, from the first position to the second position. The lock member is movable between an unlocked position and a locked position. In the unlocked position, the carriage is movable between the first position and the second position. In the locked position, the carriage is prevented from moving to the first position.

In some examples, the roller assembly further comprises at least one biasing member applying a force biasing the carriage from the first position toward the second position.

In some examples, the roller includes a wheel having an axle coupled to the carriage.

In some examples, the roller includes a sphere.

In some examples, a foot body is coupled to the bottom end of the rail, wherein the carriage is slidably coupled to the foot body.

In some examples, the foot body comprises a cavity, with the carriage being slidable within the cavity.

In some examples, internal walls of the foot body encircle the carriage.

In some examples, the lock member includes a rotatable arm, wherein in response to rotation of the rotatable arm, the carriage moves from the first position to the second position. The rotatable arm may include a cam and a pivot pin extending from the cam, wherein in response to rotation of the cam, the pivot pin moves the carriage from the first position to the second position.

Another aspect of the disclosure relates to a foot for a ladder, with the foot comprising: a body attachable to a bottom end of a rail of a ladder, the body having a bottom surface; a roller rotatable relative to the body and movable relative to the body between an extended position and a retracted position; wherein when the roller is in the extended position, the roller extends below a bottom surface of the body; wherein when the roller is in the retracted position, the roller is positioned at or above the bottom surface of the body; and a spring configured to apply a force to the roller, the force urging the roller from the retracted position toward the extended position.

In some embodiments, the foot further comprises a lock arm operable to lock the roller at or above the retracted position relative to the body.

In some examples, the body comprises a laterally inner side, wherein the roller is positioned on the inner side of the body.

In some examples, the body comprises an upper body and a lower body, wherein the bottom surface is positioned on the lower body, wherein the lower body comprises a first material more resiliently flexible than a second material of upper body.

In some examples, the body is configured to attach to the bottom end of the rail at a non-orthogonal angle relative to the bottom surface. In some examples, the body comprises a front toe, wherein when the roller is in the extended position, the roller is positioned above a plane, with the plane being orthogonal to the non-orthogonal angle and intersecting the front toe.

In some embodiments, the roller comprises a roller member and a carriage member, the roller member being rotatable relative to the carriage member, the carriage member being slidably coupled to the body.

Yet another aspect of the disclosure relates to a ladder assembly, comprising: a first assembly including: a first pair of rails spaced apart from each other; a first set of horizontal members extending between and coupled to the first pair of rails; a second assembly including: a second pair of rails spaced apart from each other, the second pair of rails being rotatably coupled with the first pair of rails; a second set of horizontal members extending between and coupled to the second pair of rails; a pair of roller assemblies positioned at respective bottom ends of the first pair of rails, each roller assembly of the pair of roller assemblies including: a wheel; a biasing member; and a locking member, wherein the wheel is biased away from the respective bottom end by the biasing member to an extended position; wherein, in response to application of a downward force to the first assembly or to the second assembly, the wheel is retractable to or above the bottom end to a retracted position; and wherein the locking member is configured to lock and unlock the wheel in the retracted position.

In some embodiments, the locking member is rotatable between a first position locking the wheel in the retracted position and a second position permitting movement of the wheel to the extended position.

In some examples, the pair of roller assemblies comprises at least one housing, wherein when the wheel is in the retracted position, the wheel is laterally covered by the at least one housing.

In some examples, in response to rotation of the locking member, the wheel translates relative to the bottom surface.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a perspective view of a ladder including a roller assembly.

FIG. 2 is a perspective view of a roller assembly of FIG. 1.

FIG. 3 is a perspective view of the bottom of roller assembly of FIG. 2.

FIG. 4 is an exploded view of the roller assembly of FIG. 2.

FIG. 5A is a cross-sectional view of the roller assembly of FIG. 2 in an extended position as taken along section indicator A-A in FIG. 3.

FIG. 5B is a cross-sectional view of the roller assembly of FIG. 2 in the extended position as taken along section indicator B-B in FIG. 3.

FIG. 6A is a cross-sectional view of the roller assembly of FIG. 2 in an intermediate position as taken along section indicator A-A in FIG. 3.

FIG. 6B is a cross-sectional view of the roller assembly of FIG. 2 in an intermediate position as taken along section indicator B-B in FIG. 3.

FIG. 7A is a cross-sectional view of the roller assembly of FIG. 2 in a locked and retracted position as taken along section indicator A-A in FIG. 3.

FIG. 7B is a cross-sectional view of the roller assembly of FIG. 2 in the locked and retracted position as taken along section indicator B-B in FIG. 3.

FIG. 8 is a perspective view of an embodiment of a roller assembly.

FIG. 9 is an exploded view of the roller assembly of FIG. 8.

FIG. 10 is a side view of the roller assembly of FIG. 8 in an extended position.

FIG. 11 is a side view of the roller assembly of FIG. 8 in the intermediate position.

FIG. 12 is a side view of the roller assembly of FIG. 8 in a locked and retracted position.

FIG. 13 is a side view of a rail of the ladder including the roller assembly.

FIG. 14 is a perspective view of an embodiment of a roller assembly.

FIG. 15 is an exploded view of the roller assembly of FIG. 14.

FIG. 16 is a partial cross-sectional view of the roller assembly in an extended position as taken along section indicator C-C in FIG. 14.

FIG. 17 is a partial cross-sectional view of the roller assembly in an intermediate position as taken along section indicator C-C in FIG. 14.

FIG. 18 is a partial cross-sectional view of the roller assembly in a locked and retracted position as taken along section indicator C-C in FIG. 14.

FIG. 19 is a perspective view of an embodiment of a roller assembly.

FIG. 20 is an exploded view of the roller assembly of FIG. 19.

FIG. 21 is a bottom perspective view of the roller assembly of FIG. 19 in an extended position.

FIG. 22 is a bottom perspective view of the roller assembly of FIG. 19 in a locked and retracted position.

FIG. 23 is a perspective view of an embodiment of a roller assembly.

FIG. 24 is an exploded view of the roller assembly of FIG. 23.

FIG. 25 is a cross-sectional view of the roller assembly of FIG. 23 in an extended state.

FIG. 26 is a cross-sectional view of the roller assembly of FIG. 23 in a retracted state.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Ladders of the present disclosure may include a roller assembly configured to ease and accelerate movement of a ladder from place to place. Rollers (e.g., wheels) at the feet of at least one set of rails of a ladder may be spring-loaded, wherein a user can roll the ladder on the rollers while the ladder is in a substantially normal upright usage position, and the rollers can automatically retract upward when the user applies their weight (or other weight) to the first rung of the ladder (or higher), thereby allowing the non-rolling part of the foot of the ladder to support the rails with the rollers retracted upward. Furthermore, roller assemblies can include a locking structure operable to lock the rollers in a retracted position for when rolling is not desired. Rollers can be positioned at four feet of an upright freestanding ladder, thereby providing the user with a high mobility ladder that can roll while deployed (i.e., while the rail assemblies are spread apart). In various example embodiments, a ladder can include rollers that are combined with a foot, rollers coupled to a rail separate from a foot (or to rails without feet), rollers that are wheel-shaped or spherical, rollers coupled to the rail or foot via a carriage, and locking structures that operate via cams or levers.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

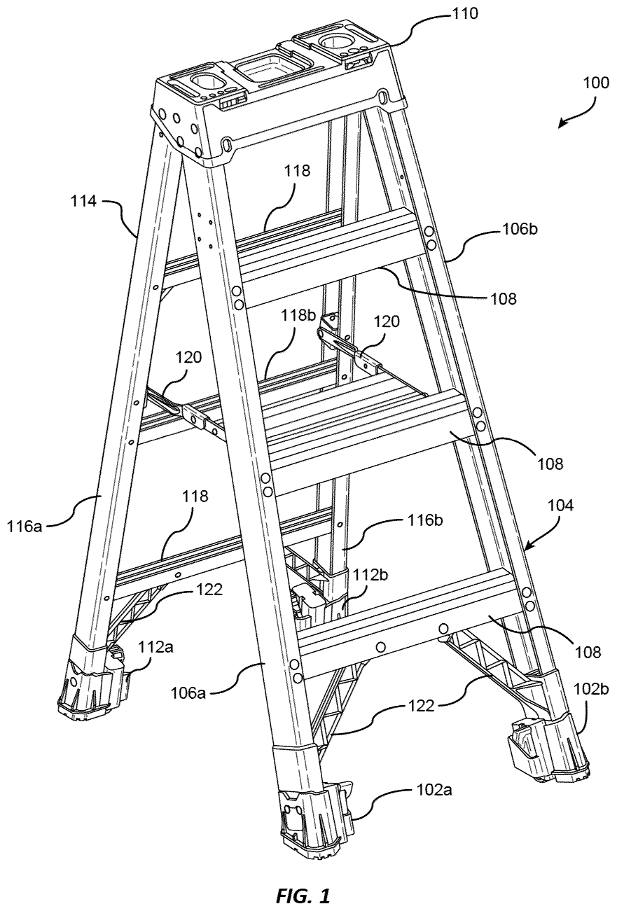

FIG. 1 is a perspective view of a ladder 100 with retractable roller assemblies 102, 112, which in some embodiments may be referred to as feet, roller feet, or foot assemblies. The ladder 100 can be referred to as a ladder assembly and is representative of various types of elevated platforms, such as step stools, scaffolds, trestles, and similar devices, all of which may be used in place of ladder 100. The ladder 100 can include a first assembly 104 including a first pair of rails 106a and 106b (collectively referred to as rails 106) spaced apart from each other. The first assembly 104 can include a first set of horizontal members, braces, steps, or rungs 108 extending between and coupled to the first pair of rails 106a and 106b.

In at least one example, the ladder 100 can include a second assembly 114 including a second pair of rails 116a and 116b (collectively referred to as rails 116) spaced apart from each other. The second assembly 114 can include a second set of horizontal members such as horizontal braces, steps, or rungs 118 extending between and coupled to the second pair of rails 116a and 116b.

The second pair of rails 116a and 116b can be rotatably coupled with the first pair of rails 106a and 106b. The second pair of rails 116a and 116b can rotate about a rotational axis coinciding with a hinge, such as a hinge formed in or by a top cap 110 or top step of the ladder 100. In some embodiments, the ladder 100 may not include a top cap 110, and at least one hinge can directly pivotally couple pairs of rails (e.g., 106a, 116a or 106b, 116b), such as in an articulating or combination ladder that is configurable into a freestanding, extension/straight, and collapsed configuration. Thus, the ladder 100 of FIG. 1 is illustrative of only one example application of the principles and features disclosed herein, and roller assemblies 102, 112 can be applied to various types of ladders.

A pair of lockable spreader bars 120 can secure the ladder 100 in an open position for use by a user, for example, by securing the second pair of rails 116a and 116b at a fixed angle relative to the first pair of rails 106a and 106b. The pair of lockable spreader bars 120 can be folded, such as when the ladder 100 is collapsed for storage. Accordingly, the ladder 100 can have a freestanding configuration, as shown in FIG. 1, in which four feet 102, 112 of the ladder 100 support the ladder 100 on a generally horizontal surface. The ladder 100 can also be folded to a collapsed position in which the rails 106, 116 are substantially parallel to each other, the lockable spreader bars 120 are pivoted to a collapsed state, and the feet 102, 112 are approximated relative to the freestanding configuration. As further described below, the ladder 100 can also be moved to a tilted position wherein two feet (e.g., 102a, 102b or 112a, 112b) support the ladder 100, whether the rails 106, 116 are spread or collapsed. The ladder 100 can also optionally include one or more bottom brace(s) 122 to provide rigidity and support between the rungs 108, 118 (e.g., the bottom-most rungs) and the rails 106, 116.

The ladder 100 can include a first pair of roller assemblies 102a and 102b positioned at respective bottom ends of the first pair of rails 106a and 106b. The ladder 100 can include a second pair of roller assemblies 112a and 112b positioned at respective bottom ends of the second pair of rails 116a and 116b. As will be described in further detail below, the roller assemblies 102a, 102b, 112a, and 112b can be configured to: (i) in a first position, deploy a set of wheels or other rollers to allow a user to easily move or reposition the ladder 100 by rolling the ladder 100 on the rollers, and (ii) in a second position, retract the set of wheels or other rollers to provide stability when the user mounts the ladder. The rollers can be locked in the second position or unlocked in the second position. In an unlocked state, the rollers can be automatically extended from the feet when a downward force (e.g., a user's weight) on the ladder 100 is removed from the ladder 100 to facilitate immediate repositioning. In a locked state, the rollers can be held in a retracted position to prevent any rolling, even when the ladder is not weighed down.

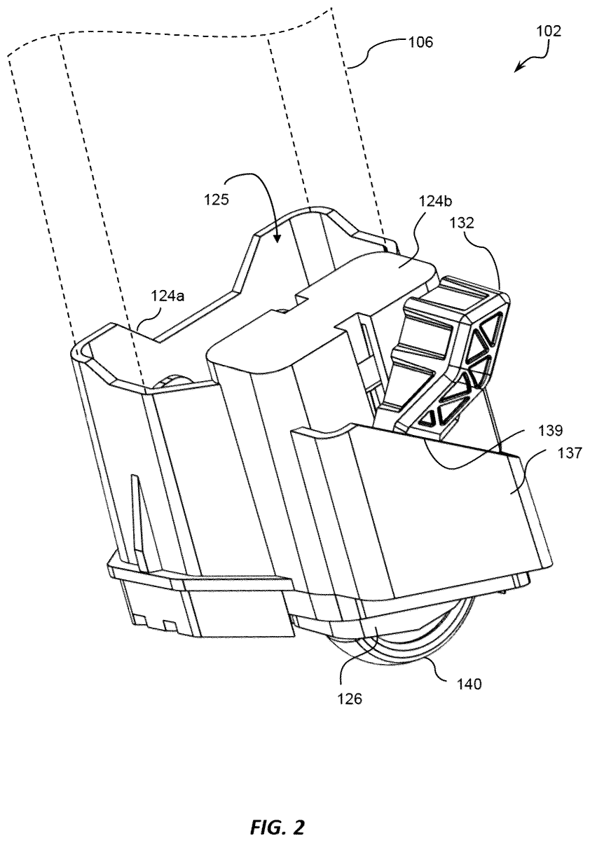

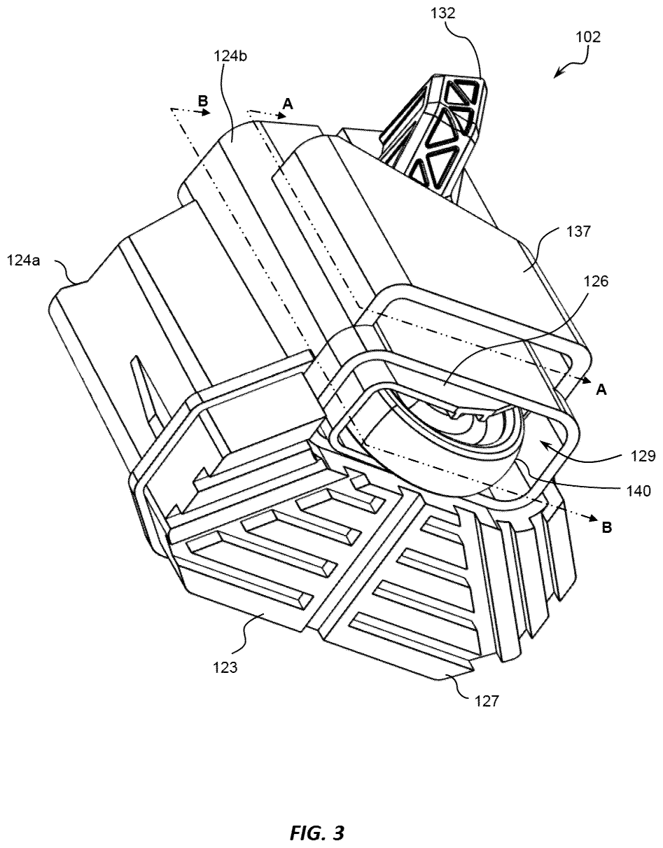

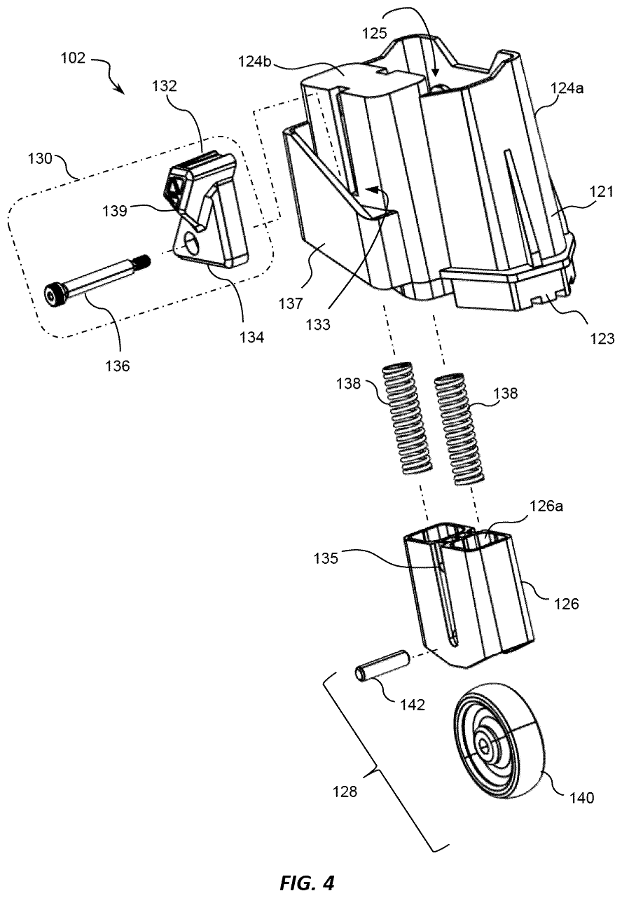

FIGS. 2-3 are perspective views of a representative roller assembly 102 of the ladder 100. FIG. 4 is an exploded view of the roller assembly 102. As explained below, the rollers of the roller assemblies 102/112 can be positioned on a laterally inner side of the rails 106/116. Thus, roller assembly 102 can be used with rails 106b and 116a, and a mirrored/horizontally inverted version of the roller assembly 102 can be used as either of the roller assemblies for rails 106a and 116b. To avoid undue repetition, the roller assemblies 102, 112 will be referred to with the roller assembly of FIG. 2 as a representative.

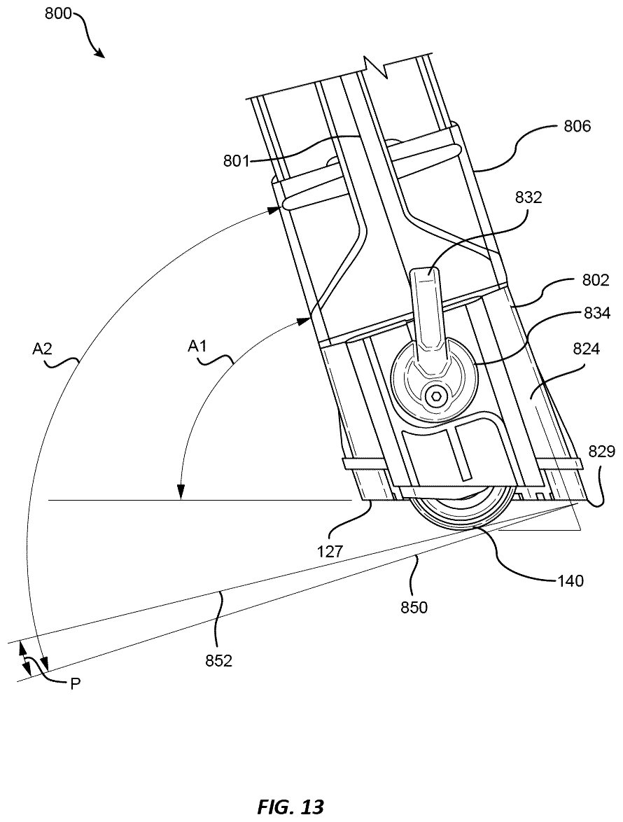

As used herein, a “longitudinal” or “longitudinally”-facing direction refers to a direction parallel to the major longitudinal axis of a rail 106, 116 to which the roller assembly 102/112 is directly attached (e.g., axis 801 in FIG. 13 which is the longitudinal axis of rail 806). A downward longitudinal direction refers to a direction parallel to the longitudinal direction and oriented substantially downward (e.g., away from the top cap 110 and toward the ground), and an upward longitudinal direction refers to a direction parallel to the longitudinal direction and oriented substantially upward (i.e., toward the top cap 110 and away from the ground). Furthermore, as used herein, a “lateral” direction is substantially horizontally oriented when the ladder is in an upright, e.g., freestanding, position. A left lateral direction extends to the left of the user when the user is standing in front of the ladder in a position about to step onto the first rung 108, and a right lateral direction extends opposite the left lateral direction, to the right of the user in that position. A front lateral direction faces toward the user from the ladder in that position, and a rear lateral direction faces away from the user on the side opposite the user (relative to the ladder) in that position.

The roller assembly 102 can be attached to the bottom end of a rail (e.g., 106, 116) of the ladder 100. The roller assembly 102 can include a body or housing 124 (also referred to as a foot body) attachable to a bottom end of the rail 106 of the ladder 100. The housing 124 can include a laterally outer side housing portion 124a (e.g., a rail coupling portion, rail attachment portion, or rail receiving body) defining a rail cavity 125 (e.g., a coupling portion or rail connection opening) on a lateral outer side of the housing 124, and the cavity 125 can include internal walls configured to encircle and cover the end of a rail (e.g., rail 106) inserted into the cavity 125. In some cases, the housing 124 can fully enclose the bottom tip of the rail, and in some cases the housing 124 can encircle the rail without covering the bottom tip, i.e., the bottom tip can be exposed at (or extend through and beyond) the bottom of the housing 124. The rail may therefore be attached to the roller assembly 102 via fasteners (e.g., screws or rivets), adhesive (e.g., epoxy), comolding, similar techniques, and combinations thereof to keep the roller assembly 102 attached to the rest of the ladder 100.

In some embodiments, rather than attaching to the end of a rail 106, the roller assembly 102 may be attached to the bottom end of another extension member, such as a lateral/diagonal stabilizer leg, extension leg, leveler leg, or similar elongated, generally vertical support structure of the ladder 100 or other elevated platform apparatus. Thus, the relationship between the bottom end of a rail 106 and the roller assembly 102 can be applied to these other structures but will not be described individually to avoid undue repetition, as will be understood by those having skill in the art and the benefit of the present disclosure.

The roller assembly 102 can also include a carriage 126 slidably coupled to the housing 124 in a laterally inner side housing portion 124b (e.g., a carriage receiving portion, a wheel connection portion, or a roller guard) defining a carriage cavity 129, and the carriage 126 can be configured to be slidable within the housing portion 124b relative to the rail 106. See FIGS. 3-4. In some embodiments, the laterally outer side housing portion 124a and the laterally inner side housing portion 124b can be separate housings coupled to each other, wherein they do not share a common integrated wall feature but may be separate parts attached to each other (e.g., via fasteners, clips, adhesives, etc.).

The carriage 126 can be slidable within the carriage cavity 129. The laterally inner side housing portion 124b can be positioned on the laterally inner side of the rail 106 (and on the laterally inner side of the laterally outer side housing portion 124a) in order to minimize the overall lateral width of the ladder 100, which can be advantageous for shipping, storage, and packaging purposes. Laterally inner side housing portion 124b can also be positioned on the laterally inner side to help avoid damage to the housing portion 124b since the laterally outer sides of the ladder 100 can be generally more exposed to bumps and breaking, including while carrying and moving the ladder 100 in freestanding and collapsed conditions. However, in various embodiments, the housing portion 124b can be positioned on a laterally outer side of the rail 106 or on a laterally front or rear side thereof. The roller can be referred to as being positioned on the inner side of the body, meaning the roller is configured to be on a side of the housing 124 that the lateral inner half of the housing 124.

In some embodiments, the roller assembly 102 may omit the rail receiving cavity 125 and the walls surrounding the cavity on the front, back, and/or laterally outer sides of the rail 106. Thus, in that case, the housing 124 can comprise only the laterally inner side housing portion 124b with carriage cavity 129 (and without receiving the rail 106 in a laterally outer side housing portion 124a). The housing 124 (e.g., housing portion 124b) can be attached to a side surface of the rail 106 (or a conventional ladder foot or other bottom structure of a vertical support) without encircling the rail 106 within a cavity or rail-receiving housing portion (e.g., 125, 124a). This configuration can be beneficial to enable retrofitting a ladder to include rollers of the present disclosure without having to customize the roller assembly to fit around and receive the bottom end of an existing foot or rail.

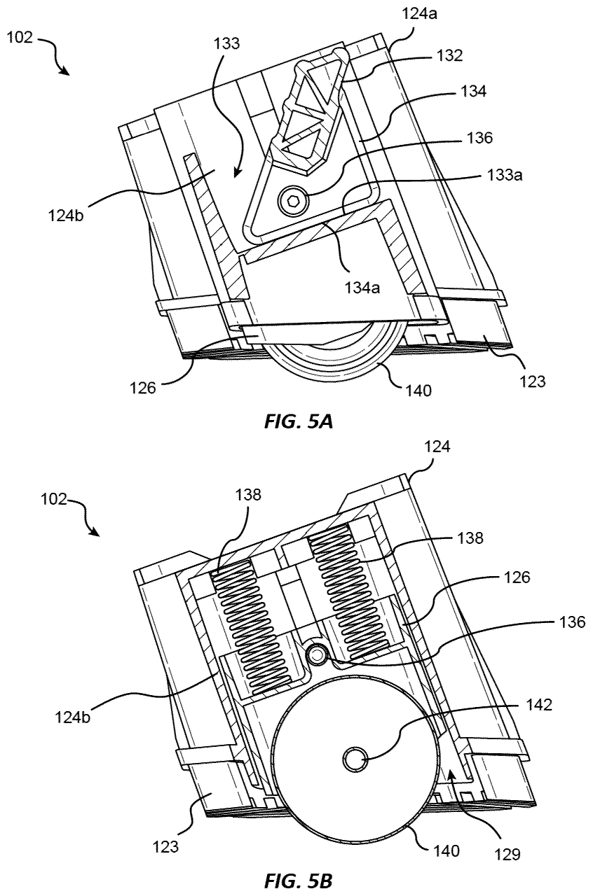

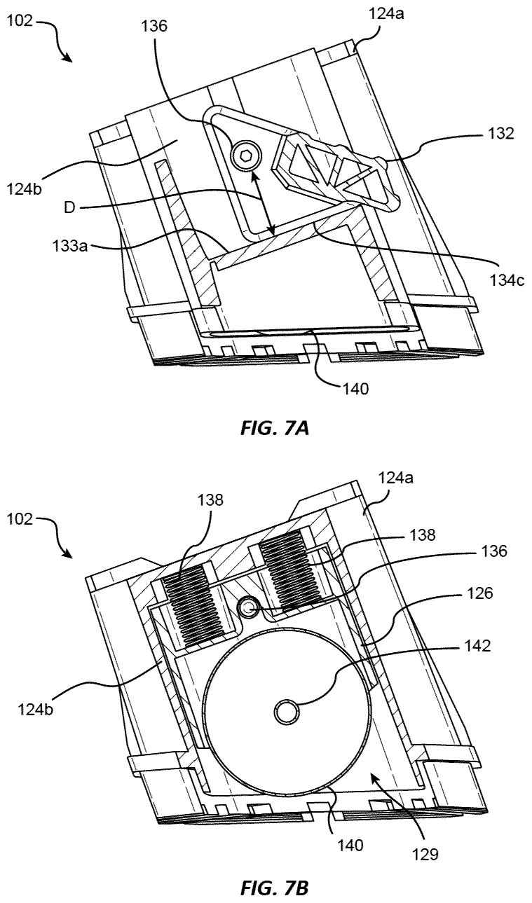

The roller assembly 102 can include a roller 128 rotatably coupled to and movable with the carriage 126 relative to the rail 106 and housing portion 124b in cavity 129. As described with reference to FIGS. 5A-7B, the roller assembly 102 can be movable between a first or extended position (shown in FIGS. 5A-5B), wherein the roller 128 at least partially extends below a bottom end surface 127 of the rail 106 (and housing 124), and a second or locked and retracted position (shown in FIGS. 7A-7B) wherein the roller 128 is retracted relative to the first position above the bottom end of the rail 106. In other words, the roller 128 translates longitudinally upward relative to the bottom surface 127. In the retracted position, the wheel 140 can be laterally covered by the housing portion 124b. The roller 128 can include a wheel 140 having an axle 142 coupling the wheel 140 to the carriage 126 and defining the axis of rotation of the wheel 140.

In some embodiments, the wheel 140 and axle 142 can be connected to a caster support joined to the carriage 126. For example, the wheel 140 and axle 142 can be rotatable about a vertical axis (or about a rail longitudinal axis) when in an extended position in addition to being rotatable about a horizontal axis through the axle 142. In this case, the wheel 140 can be referred to as a caster wheel and can enable rolling of the ladder in multiple perpendicular lateral directions, such as rolling laterally to the left and right sides of the ladder and laterally to the front and back sides of the ladder. The caster wheel can be retractable to (or above) a bottom surface 127 of the housing 124, similar to wheel 140, as described herein. In various examples, the caster wheel may or may not be entirely received within the carriage cavity 129.

The roller assembly 102 can include at least one biasing member 138 configured to apply a force biasing the carriage 126 from the second, retracted position toward the first, extended position. The biasing members 138 of assembly 102 can have ends configured to engage a substantially longitudinally-upward-facing surface of the carriage 126 (within top cavities (e.g., 126a) that receive the biasing members 138) and a substantially longitudinally-downward-facing surface the carriage cavity 129, as shown in FIGS. 5B, 6B, and 7B.

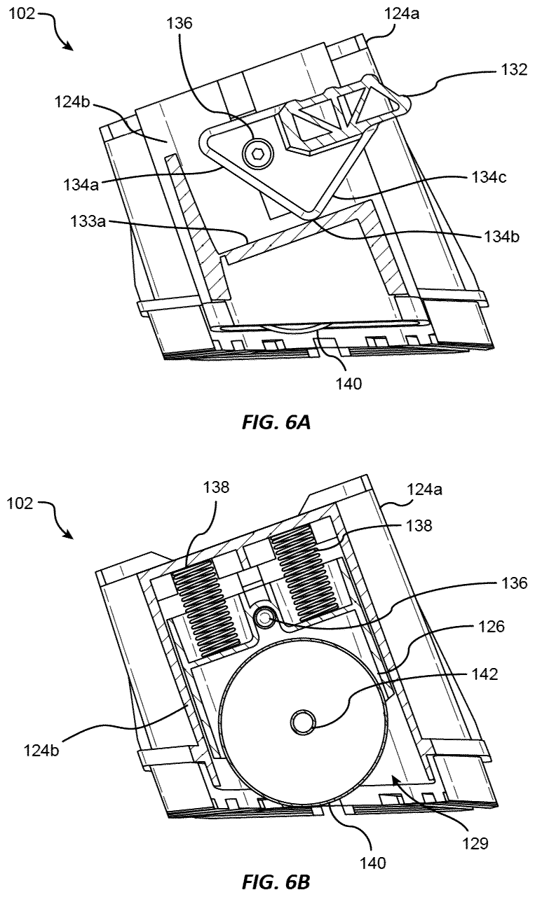

The biasing members 138 can comprise springs (e.g., coil springs, leaf springs, compression springs, similar devices, and combinations thereof) to urge the carriage 126 longitudinally downward and toward the ground. The biasing members 138 can apply sufficient force that, when the ladder 100 is not substantially loaded (e.g., when a user is not standing on the ladder 100), the ladder 100 can be entirely supported by and rolled on the wheels 140 without contact between the bottom surfaces 127 of the rails or feet/roller assemblies 102 and the ground. However, the biasing members 138 may also apply a proper force that, when the ladder is loaded by a downward force by a predetermined weight (e.g., the weight of an expected or average user), the biasing force can be overcome, thereby causing the wheels 140 to retract to the position of FIGS. 6A-6B and for the ladder 100 to be supported by the bottom surfaces 127 of the rails or feet/roller assemblies 102.

The roller assembly 102 can include a lock member 130 movable between an unlocked position (e.g., a first rotated position) and a locked position (e.g., a second rotated position). The lock member 130 can include a rotatable arm 132 and a pivot pin 136 (e.g., a bolt, fastener, pivot arm, etc.). In some embodiments, the arm 132 and pivot pin 136 can be integrally formed. For example, the arm 132 and pivot pin 136 can be formed as a single unitary part having a rod portion (shaped similar to pin 136) usable as a pivot pin and extending from a rotatable arm portion (shaped similar to rotatable arm 132).

The pivot pin 136 can define a pivot axis around which the rotatable arm 132 can rotate between multiple positions, as shown in FIGS. 5A-7B. The pivot pin 136 can extend through a pin opening 135 of the carriage 126 (see FIG. 4) and can therefore move with the carriage 126 and wheel 140 relative to the housing 124, as illustrated in FIGS. 5B, 6B, and 7B.

The rotatable arm 132 can be rotatable about the pivot pin 136 within an arm slot 133 on the inner side of the inner side housing portion 124b. See FIGS. 4 and 5A. The arm slot 133 can be defined between the inner side housing portion 124b and a guard wall 137 positioned laterally inward from the inner side housing portion 124b. The guard wall 137 can protect the lock member 130 from bumps, scrapes, and debris and can help prevent objects from being pinched in the slot 133. In some embodiments, the guard wall 137 can also be engageable with the rotatable arm 132, as shown, for example, in FIG. 2, wherein rotation of the rotatable arm 132 in a direction away from the front open end of the slot 133 is prevented by contact between a laterally-protruding portion 139 of the rotatable arm 132 and a top surface of the guard wall 137.

The rotatable arm 132 can include a cam 134, (e.g., a cam portion, right angle portion, triangular portion, or housing contact portion). The cam 134 can have a substantially triangular shape enabling the lock member 130 to be biased, via the by the interconnection of the biasing members 138, carriage 126, and pivot pin 136, into the locked and unlocked positions of the lock member 130. With the lock member 130 in the unlocked position, the carriage 126 may be movable between the first position and the second position and vice versa (e.g., in response to a force overcoming the biasing force applied by the biasing members 138). In the locked position, the carriage 126 may be prevented from moving to the first position from the second position because the pivot pin 136 may hold the carriage 126 in a raised position within the inner side housing portion 124b.

FIGS. 5A-7B illustrate cross-sectional views of the roller assembly 102 in various configurations. FIGS. 5A-5B are cross-sectional views of the roller assembly 102 along lines A-A and B-B in FIG. 3, respectively, while the roller assembly 102 is in the first position (e.g., a rest position, unlocked position, or extended position). FIGS. 6A-6B are similar cross-sectional views of the roller assembly 102 with the carriage 126 and lock member 130 in an intermediate unlocked and retracted position, and FIGS. 7A-7B are cross-sectional views of the roller assembly 102 in the second position (e.g., a raised position, retracted position, or locked position), with the carriage 126 and lock member 130 held in place by the biasing members 138. FIGS. 5A-7B illustrate translation of the wheel 140 relative to the bottom surface 127 in response to rotation of the lock member.

In the unlocked position, the lock member 130 allows the carriage 126 to be movable between the first position and the second position, e.g., in response to a user stepping on a rung of the ladder 100. In the position of FIG. 5A, the wheel 140 extends below a bottom surface 127 of the rail 106 (and a bottom surface of the housing 124 and any lower body 123 positioned thereon). The biasing members 138 can apply a force biasing the carriage 126 to the first position at which the potential energy of the cam 134 is at a local minimum due to a first cam surface 134a (e.g., an unlocked-biased surface portion or first flat/flattened side surface) of the cam 134 contacting a flat/flattened inner surface 133a of the slot 133. In other terms, the biasing members 138 can apply a force to the pivot pin 136 (via the carriage 126) to hold the lock member 130 in the position of FIG. 5A while the wheel 140 is extended. The roller assembly 102 may be in the position of FIG. 5A when there is no external downward force exerted on a rung 108 of the set of rungs. In other words, the roller assembly 102 may be in the first position when there is no user standing on the ladder 100, wherein the wheel 140 extends below the bottom surface 127 of the housing 124 (or lower body 123), thereby allowing the user to easily move the ladder 100 by rolling the ladder 100 on the wheel 140.

When a user exerts a sufficient downward force on a rung 108 to overcome the biasing force of the biasing members 138, such as by standing on the ladder 100, the roller assembly 102 can be pushed upward to move from the first position of FIGS. 5A-5B to the position of FIGS. 6A-6B, wherein the wheel 140 is retracted to (or above) the bottom surface 127 of the housing 124. In the second position, the bottom surface 127 of the housing 124 (or lower body 123) can contact the ground or other underlying support surface to provide stability and prevent rolling motion of the ladder 100 when the user is weighing down the ladder 100.

Upward movement of the wheel 140 also causes upward movement of the carriage 126 and pivot pin 136, which thereby causes the rotation arm 132 to move upward, as shown in FIG. 6A. The upward movement of the rotation arm 132 causes the first cam surface 134a to move away from the flat/flattened inner surface 133a. The center of gravity of the rotation arm 132 is positioned to the front of the pivot pin 136 (right side of FIG. 6A), so the arm 132 rotates about the pivot pin 136 until reaching a position where a pointed portion 134b of the cam 134 contacts the inner surface 133a. Thus, the cam 134 can be positioned with one corner or vertex in tangential contact with the inner surface 133a. When the downward force is removed from the rung 108, the cam 134 rotates back to the position of FIG. 5A in response to the action of the biasing members 138. In other words, when a user steps onto the rung 108, thereby moving the wheel 140 to the position of FIG. 6A, the cam 134 does not angularly displace past a threshold angular displacement needed (e.g., 45 or more degrees of rotation about pin 136) to move the rotation arm 132 to a position where a second cam surface 134c (e.g., a second flattened side portion) of the cam 134 contacts the inner surface 133a (i.e., about 90 degrees of rotation, to the position of FIG. 7A) when weight is removed. This allows the carriage 126 to automatically reset to its roller-extended position anytime weight is taken off the ladder 100.

In some cases, the user may opt to make the roller 128 remain in the raised position even when the user is not standing on the ladder 100. In such instances, the lock member 130 can be rotated from the position of FIG. 5A to the position of FIG. 6A (e.g., via clockwise rotation about the pivot pin 136 in the view of FIGS. 5A and 6A in response to downward pressure on the arm 132) and then finally to the locked position shown in FIGS. 7A-7B. Rotation of the rotatable arm 132 rotates the cam 134, and, in response to rotation of the cam 134, the pivot pin 136 moves the carriage 126 upward. In other words, the wheel 140 is held at or above the bottom surface 127 of the housing 124.

In the locked position, the carriage 126 and the roller 128 are prevented from moving back to the first position because the pivot pin 136 is raised sufficient to keep the wheel 140 at or above the ground or underlying support surface of the ladder 100. The pivot pin 136 is held at the sufficiently raised position due to contact between the second cam surface 134c and the inner surface 133a of the housing. The distance between the pivot pin 136 and the second cam surface 134c (e.g., distance D) is greater than the distance between the pivot pin 136 and the first cam surface 134a, so the wheel 140 remains lifted while the arm 132 is rotated to the locked position. Furthermore, the biasing members 138 urge the pivot pin 136 downward (via the carriage 126), so a biasing force of the biasing members 138 must be overcome when rotating the arm 132 upward and away from the locked position.

The lock member 130 can be moved back into the unlocked position (e.g., FIG. 5A) when an upward force is applied to the rotatable arm 132 that overcomes the forces on the pin 136 by the biasing members 138, thereby making the arm 132 move back to the position of FIG. 6A and then to the position of FIG. 5A. The arm 132 may be prevented from rotation past the unlocked position (e.g., counterclockwise movement past the position of FIG. 5A) due to contact between the arm 132 (at 139) and the guard wall 137.

The body or the housing 124 can include an upper body 121 on which a lower body 123 (e.g., a foot pad, engagement pad, or resilient block) is mounted. The lower body 123 can bear the bottom surface 127. The lower body 123 can include a first material which is more resiliently flexible or compressible than a second material of the upper body 121. The first material of the lower body 123 can be configured to absorb impact and to provide grip along the ground to provide additional stability to the ladder 100 when the roller assembly 102 is in the second position and/or the user is mounted on the ladder 100 and the ladder 100 is supported by contact between the ground and the lower body 123. In contrast, the second material of the upper body 121 may be rigid so as to provide support for the roller assembly 102 on the rail 106.

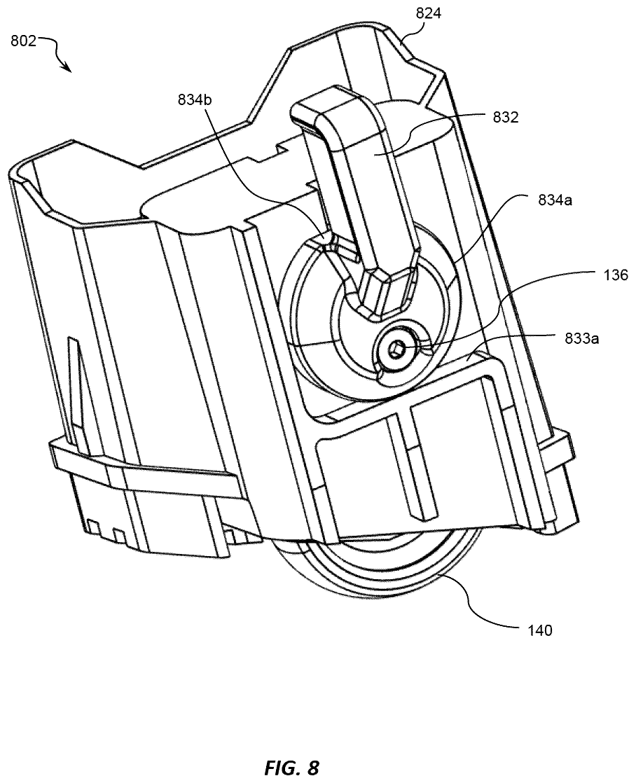

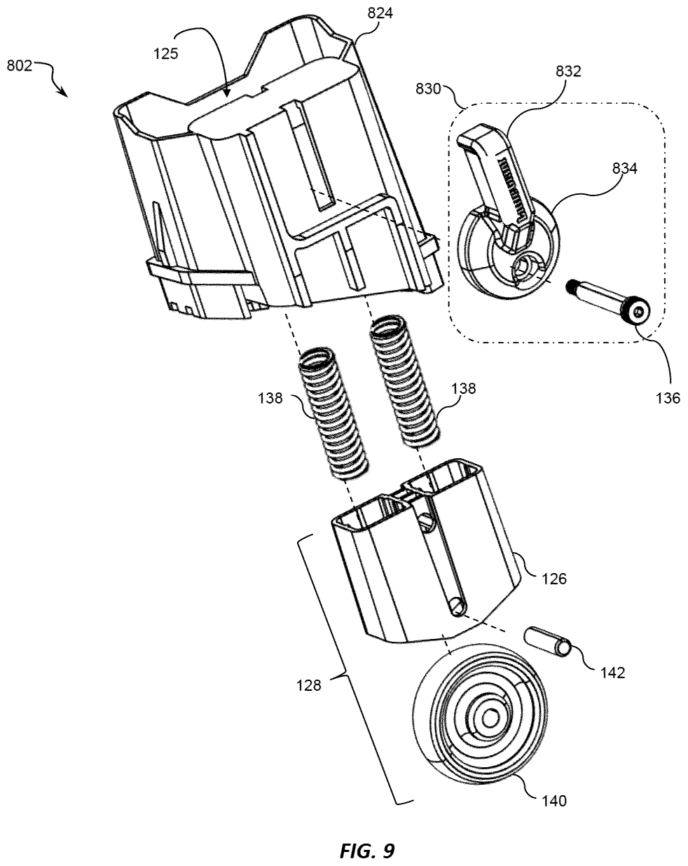

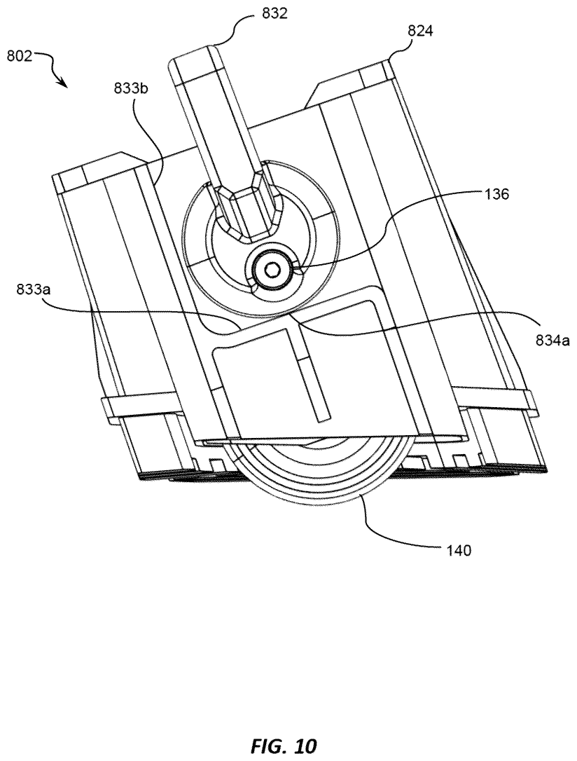

FIGS. 8-12 relate to an alternate embodiment of a roller assembly 802. FIG. 8 is a perspective view of the roller assembly 802. FIG. 9 is an exploded view, and FIGS. 10-12 are side views in an unlocked/extended state, an intermediate unlocked/retracted state, and a locked/retracted state, respectively. The roller assembly 802 can be configured substantially similar to roller assembly 102, except where noted otherwise. For example, roller assembly 802 can be attached to a bottom end of a rail of a ladder, such as the rail 106 of ladder 100.

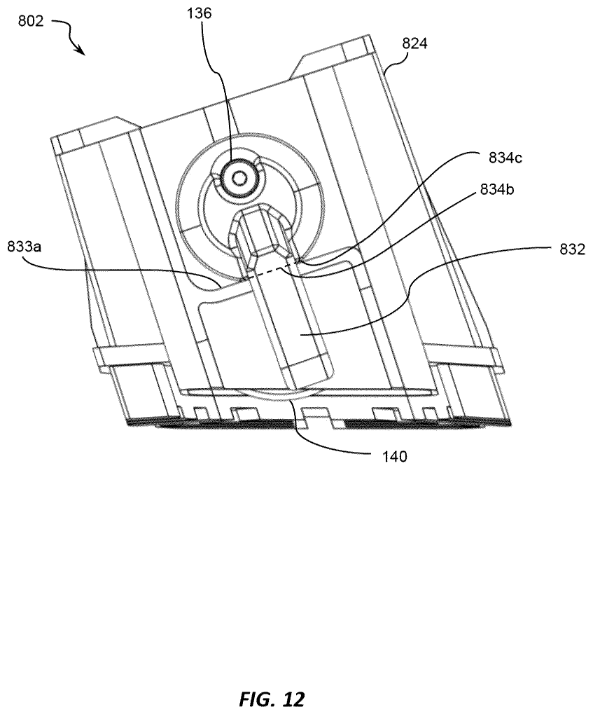

The lock member 830 of the roller assembly 802 can have a mostly circular cam 834, in contrast to the straight sided, angled shape of the rotatable arm 132 and cam 134 of the roller assembly 102. The lock member 830 can be mounted to a housing 824 mostly similar to housing 124 but lacking a guard wall 137. The lock member 830 can include a rotatable arm 832 and a cam 834. The rotatable arm 832 can rotate about a pivot pin 136 that is offset from a center of the surface of the cam 834 of the lock member 830. Thus, when the cam 834 is in the upright, unlocked position of FIGS. 8 and 10, a first distance between a lower cam support surface 833a of the housing 824 at a rounded contact surface 834a of the cam 834 and the pivot pin 136 is less than a second distance between the lower cam support surface 833a and the pivot pin 136 when a flattened cam surface 834b of the cam 834 contacts the lower cam support surface 833a in the locked position of FIG. 12. The pivot pin 136 therefore moves upward to retract the carriage 126 and wheel 140 as the lock member 830 is rotated from the unlocked to the locked position, similar to roller assembly 102. Surface 834b is shown using a broken line in FIG. 12 since it is positioned behind arm 832.

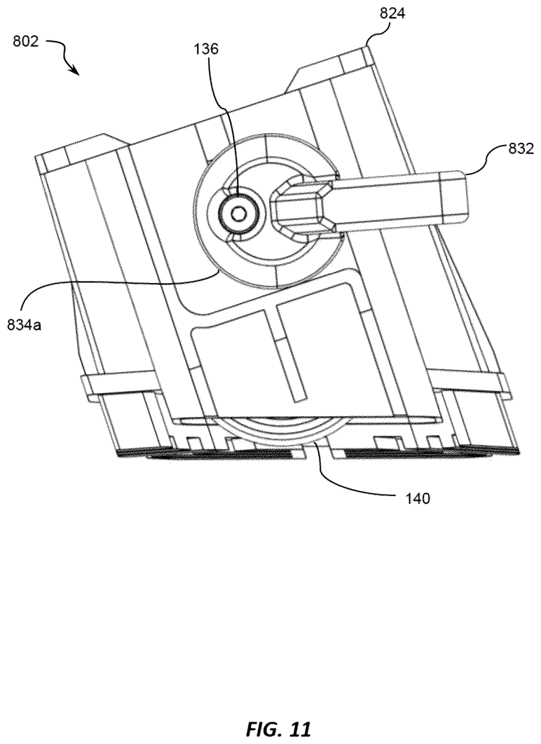

Furthermore, the flattened cam surface 834b can rest against the lower cam support surface 833a at a slightly smaller radial distance than a round surface portion 834c of the cam 834 immediately adjacent to the flattened cam surface 834b. This flattened cam surface 834b therefore can provide stability to the cam 834 while it is in the unlocked position and requires the user to overcome a minimum amount of force, as applied by the biasing members 138, to begin to unlock the lock member 830 (i.e., to rotate away from the position of FIG. 12 onto surface portion 834c and toward the position of FIG. 11). The minimum amount of force may help limit or prevent accidental unlocking of the carriage 126.

While the roller assembly 802 is in the position of FIG. 10, weight applied to the ladder can push the wheel 140 into a retracted position. To avoid accidental locking of the wheel 140 due to the pivot pin 136 moving upward while the rounded contact surface 834a contacts the lower cam support surface 833a, e.g., to prevent movement to the positions of FIGS. 11-12, the lock member 830 can be configured with an unlocked position (FIG. 10) that has the center of gravity of the lock member 830 positioned on the rear side (e.g., the left side in FIG. 10) of the pivot pin 136. Thus, when weight is applied to the ladder and the pin 136 is pushed upward by the carriage 126, the arm 832 is biased by gravity toward the rear side (i.e., toward a longitudinal surface 833b of the housing 824). The rounded contact surface 834a therefore will rotate about pin 136 and into contact with the longitudinal surface 833b, and the cam 834 will not keep rotating. Releasing the weight on the ladder from that position would allow the pivot pint 136 and cam 834 to move back to the unlocked, extended position of FIG. 10.

FIG. 13 is a side view of a rail 806 of a ladder 800 and the roller assembly 802 with various example dimensions indicated. The rail 806 can be substantially similar to any of the rails 106a, 106b, 116a, or 116b of the ladder 100. Additionally, except for the roller assembly 802, the ladder 800 can be substantially similar to the ladder 100. Furthermore, as will be apparent to those having ordinary skill in the art, the features of roller assembly 802 as described in connection with FIG. 13 may be applied to any roller assembly or foot described herein, such as, for example, assemblies 102, 1402, 1902, 2302, etc.

When the ladder 800 is in a standing position, the bottom surface 127 of the housing 824 can be configured to be positioned parallel to the ground or support surface to maximize traction between the ladder 800 and the ground. The housing 824 can be configured to attach to the bottom end of the rail 806 at a non-orthogonal angle relative to the bottom surface 127 of the housing 124. For example, as shown in FIG. 13, the housing 824 can be attached to form an angle A1 of approximately 72 degrees between the horizontal ground plane and a longitudinal axis of the rail 806. In other examples, the angle can be greater than or less than 72 degrees.

The housing 124 can have a front toe 829 (e.g., a tip, end point, end edge, or tilt support edge). When the wheel 140 is in an extended position, the wheel 140 is positioned below the plant across the bottom surface 127 and toe 829. Additionally, when the roller is in the extended position, the bottom surface 127 can be approximately 0.48 inches above the ground or the bottom-most surface of the wheel 140. In other embodiments, the roller can extend to different distances. The ladder 800 can therefore be supported by the roller in such configuration when there is no downward force applied to any rung of the ladder 800.

The rotation axis of the wheel 140 can be positioned about halfway between the frontward- and rearward-facing surfaces of the rail 806. Thus, in an example embodiment, a distance between a center of the wheel 140 and either (front or rear) surface of the rail 806 can be about 1.60 inches, and the overall distance between the front and rear surfaces may be about 3.20 inches. Further, the axle 142 of the roller can be disposed substantially centrally in the housing 824.

At times, the user may wish to tilt the rails of the ladder 800 toward the user (e.g., with the rails 106 rotating to allow top cap 110 to pass over the first pair of feet 102) without the bottom end ladder rolling away from them on the rollers 128. The user can lock the rollers in a retracted position to prevent rolling away. However, if the rollers are extended, the front toes 829 of the housings 824 can be configured to support the ladder 100 without the wheels 140 simultaneously contacting the ground surface. For instance, the ladder 800 can be entirely supported by the toes 829, which do not roll. To enable this behavior, the toe 829 can be forwardly offset from the wheel 140 such that a plane 850 positioned at angle A2 (i.e., about 90 degrees offset from the rear surface of the rail 806 (and intersecting the toe 829)) does not intersect the wheel 140. In other words, the wheel 140 may be longitudinally upwardly offset from that plane 850, as shown in FIG. 13. A plane 852 intersecting both the bottom of the wheel 140 and the toe 829 can be offset from the plane 850 by about a four-degree angle (e.g., angle P in FIG. 13). The offset angle (P) can allow a small amount of tilt rotation of the ladder 800, while on the toe 829, without the wheel 140 re-engaging the ground.

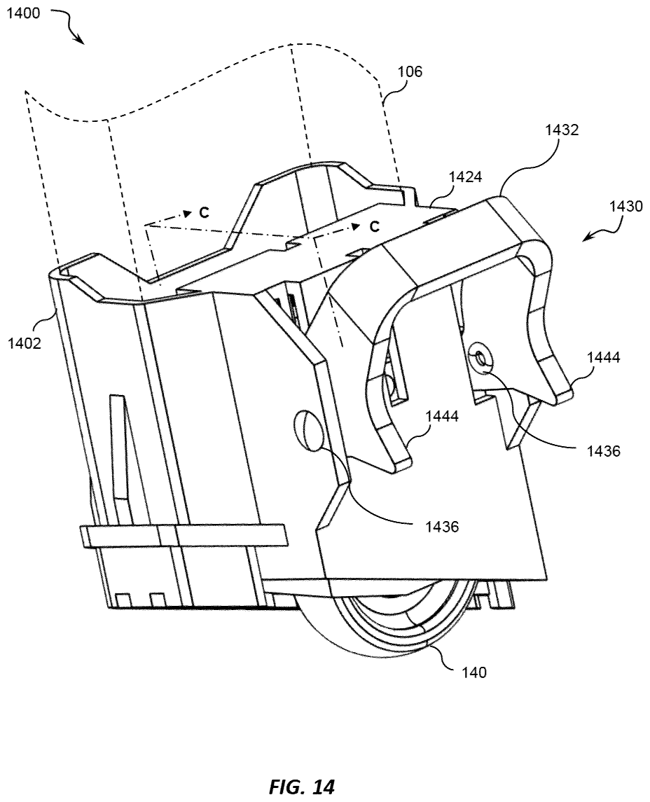

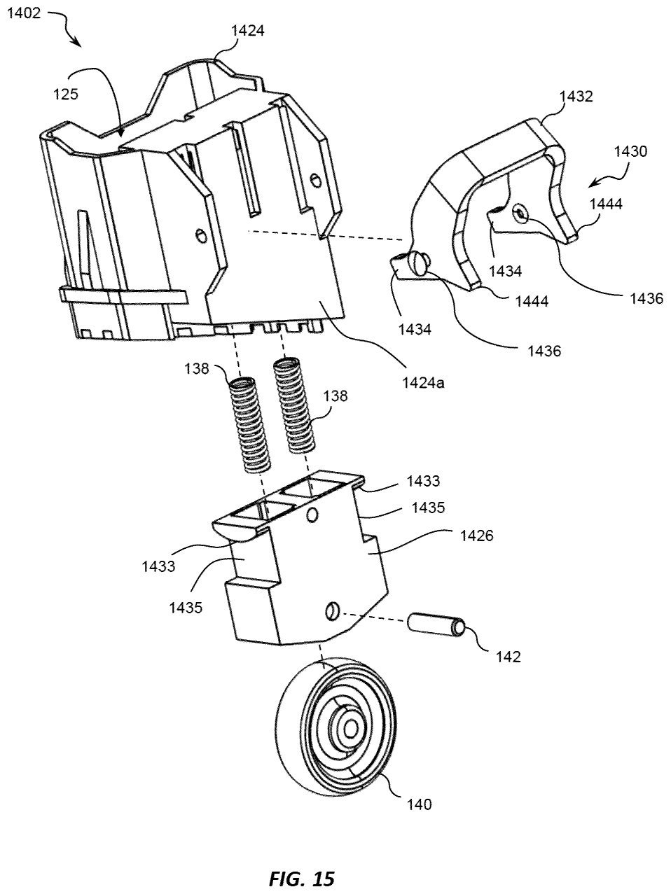

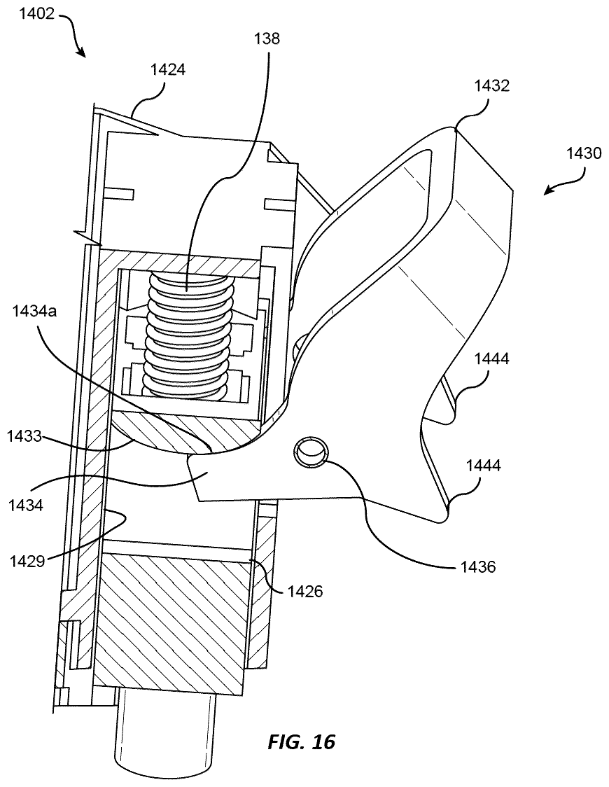

FIGS. 14-18 relate to another alternate embodiment of a roller assembly 1402 of a ladder 1400. FIG. 14 is a perspective view of the roller assembly 1402. FIG. 15 is an exploded view of the roller assembly 1402. FIGS. 16-18 are partial cross-sectional views (taken through section lines 16-16 in FIG. 14) of the roller assembly 1402 in an extended position, an intermediate retracted/unlocked position, and a retracted/locked position, respectively.

The ladder 1400 can be substantially similar to the ladder 100 and the ladder 800 aside from differences described below. The roller assembly 1402 can include a housing 1424, a carriage 1426 to receive the wheel 140 in the housing 1424, and a lock member 1430. The lock member 1430 can include a rotatable arm 1432 (e.g., a lever arm, pivoting arm, or swing arm), one or more pivot pins 1436, and one or more stops 1444.

The rotatable arm 1432 can also include one or more cam protrusions 1434 configured to extend into a carriage cavity (e.g., 1429, similar to cavity 129) in the housing 1424, as shown in FIGS. 16-18. The protrusions 1434 can engage respective one or more substantially downward-facing surfaces 1433 on the carriage 1426. Thus, engagement between the protrusions 1434 and the downward-facing surfaces 1433 can prevent the carriage 1426 from falling out of the carriage cavity 1429. The downward-facing surfaces 1433 can be defined at top ends of two opposite-positioned recesses 1435 in the sides of the carriage 1426.

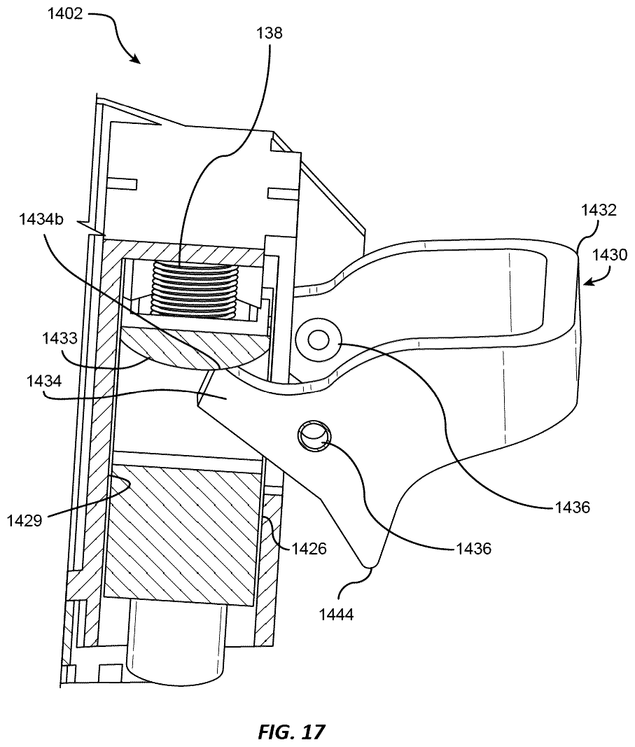

When in the position of FIG. 16, the rotatable arm 1432 can have a first carriage contact surface 1434a in contact with the downward-facing surfaces 1433 of the carriage 1426. The roller extends below the bottom surface of the housing 1424, similar to the position of FIG. 5A, and the wheel 140 and carriage 1426 are unlocked, meaning the wheel 140 and carriage 1426 can be pushed longitudinally upward in response to weight applied to a rung of the ladder until the carriage 1426 reaches the position of FIG. 17. The rotatable arm 1432 can rotate downward on its inner side, by virtue of its center of gravity being on the laterally inner side of its pivot axis as the downward-facing surfaces 1433 move upward, as shown in FIG. 17. When weight is released, the wheel 140 and carriage 1426 can be biased back out to the position of FIG. 16 by the biasing members 138 in the carriage 1426 and because the rotatable arm 1432 was not sufficiently rotated past pointed transition tips 1434b of the protrusions 1434 to cause the downward-facing surface 1433 to engage the second carriage contact surface 1434c.

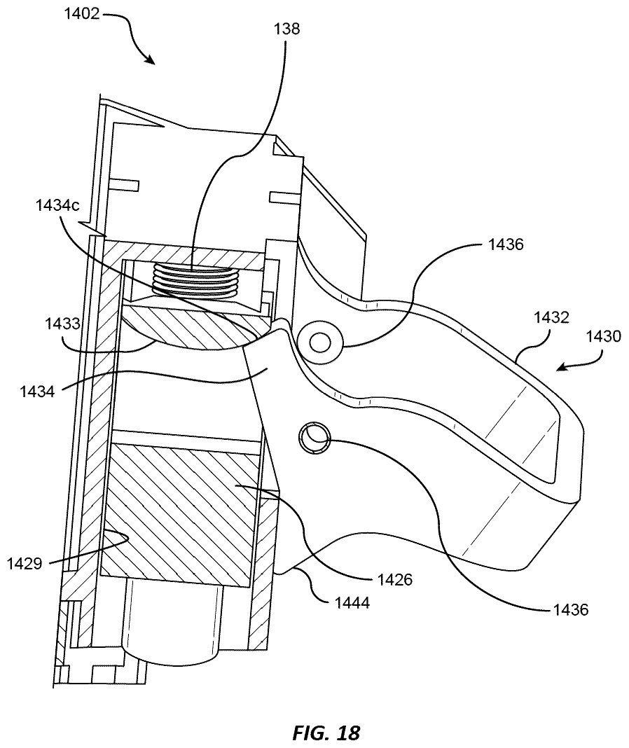

A user can transition the lock member 1430 into a locked state, thereby holding the carriage 1426 in a raised position, as shown in FIG. 18 with the wheel 140 retracted to or above the bottom surface (e.g., 127). The procedure for locking the mechanism 1430 can include pivoting the rotatable arm 1432 downward (from the position of FIG. 17) on its inward side e.g., the side having the inward-extending portion/handle/user foot engagement portion) to the position of FIG. 18, wherein the second carriage contact surface 1434c engages the downward-facing surface 1433 of the carriage 1426 and the stops 1444 engage the housing 1424. The distance from an adjacent pivot pin 1436 of the arm 1432 to the second carriage contact surface 1434c can be greater than a distance from the same pin and the first carriage contact surface 1434a, so the carriage 1426 can be held in the raised position by second carriage contact surface 1434c in the state shown in FIG. 18. The second carriage contact surface 1434c can be slightly rounded or concave to receive the convex downward-facing surface 1433 of the carriage 1426, thereby providing stability to the engagement. The first carriage contact surface 1434a can also be slightly concave to provide stability in the unlocked, extended state of the carriage 1426. The stops 1444 can prevent the rotatable arm 1432 from rotating past the locked position when the inner side of the arm 1432 moves downward.

The rotatable arm 1432 may comprise a generally U-shaped profile (when viewed from above), wherein the ends of the profile are formed by the cam protrusions 1434. The center of the rotatable arm 1432 can act as a handle or foothold to assist the user in turning the lever about the pivot pins 1436. The rotatable arm 1432 can comprise a rigid material, such as metal (e.g., steel or aluminum), and can be formed via stamping, casting, and similar methods. The stops 1444 of the arm 1432 can have a size and shape configured to distribute pressure against the laterally inner wall 1424a (see FIG. 15) of the housing 1424 in order to avoid damage to the wall 1424a if the arm 1432 is over-rotated downward.

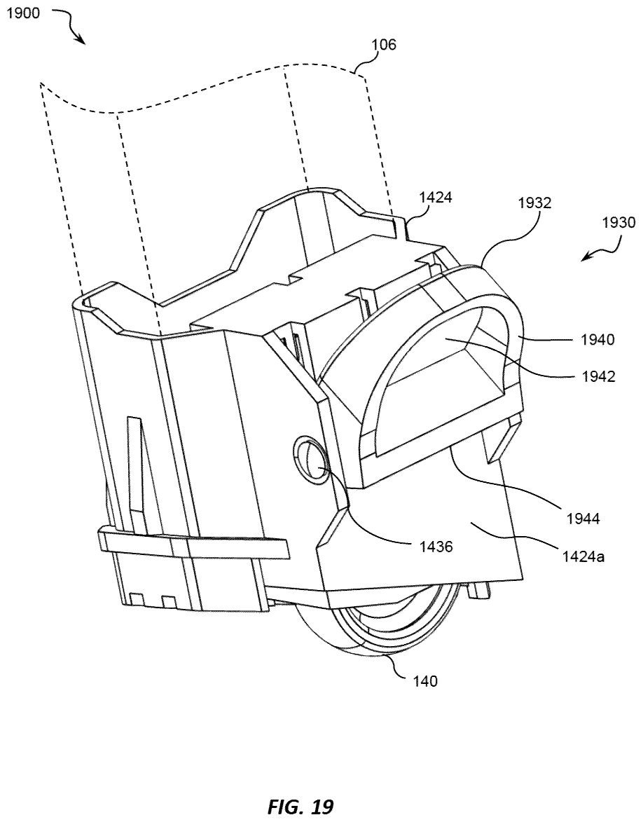

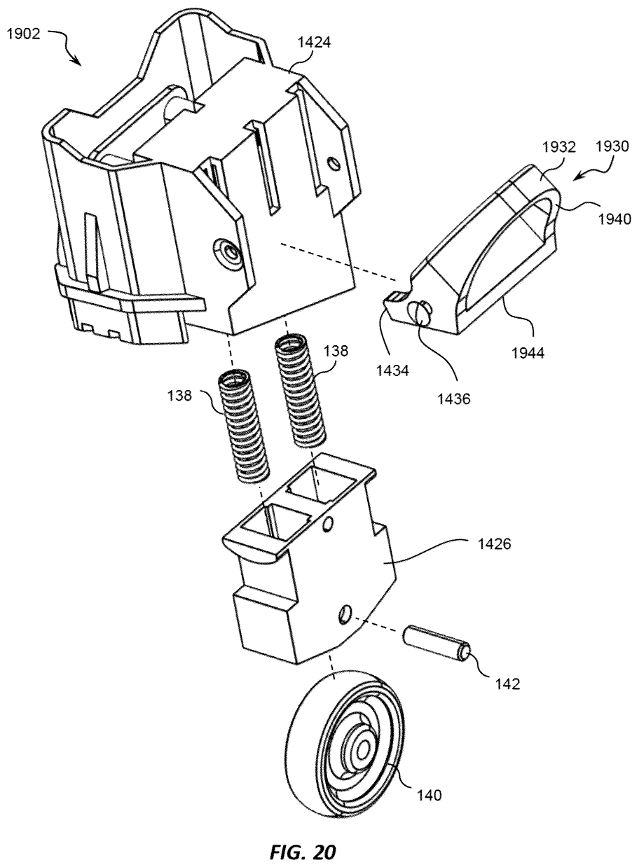

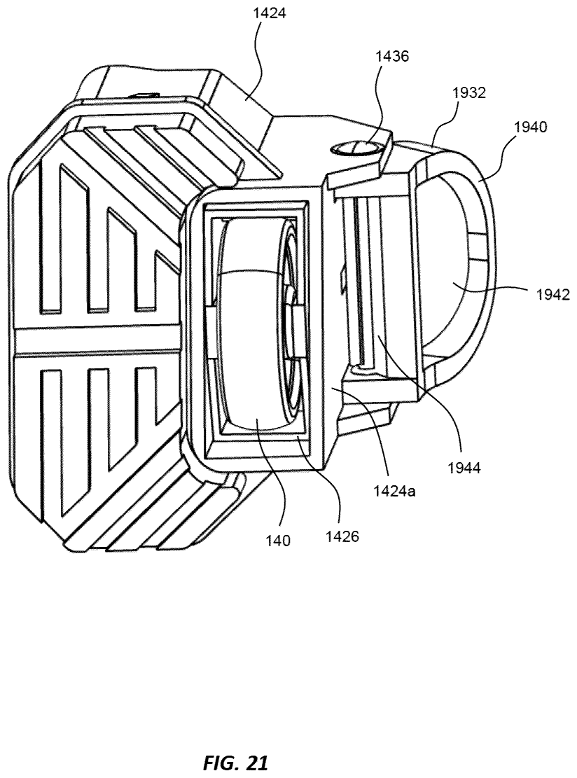

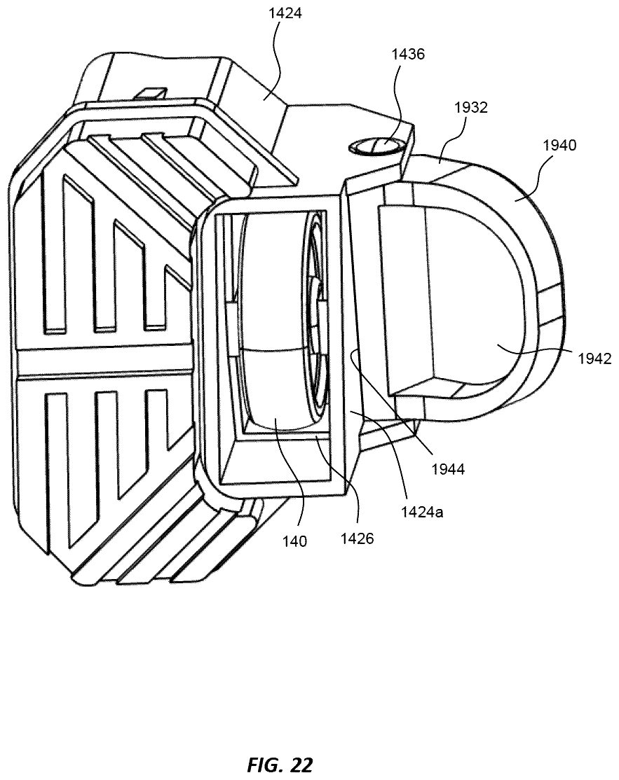

FIGS. 19-22 show another example embodiment of a roller assembly 1902 of a ladder 1900. FIG. 19 is a perspective view of the roller assembly 1902, FIG. 20 is an exploded view, and FIGS. 21-22 are bottom perspective views of the roller assembly 1902 in an extended, unlocked position and a retracted, locked position, respectively. Components and features of the roller assembly 1902 are similar or identical to other roller assemblies described above, especially assembly 1402. Thus, roller assembly 1902 incorporates the features and functions described above where applicable, including, for example, housing 1424, carriage 1426, wheel 140, biasing members 138, etc., as shown in FIG. 20.

The lock member 1930 may comprise a rotatable arm 1932 having a pair of cam protrusions 1934 that function in the same manner as cam protrusions 1434, as shown in FIGS. 21 and 22. The rotatable arm 1932 may also include a paddle or closed panel shape, wherein an outer ridge portion 1940 surrounds an inner panel 1942, as shown in FIG. 19. A lower end of the rotatable arm 1932 may include an abutment surface 1944 (see FIGS. 19 and 21) configured to rotate with the arm 1932 to abut, contact, and engage the laterally inner wall 1424a of the housing 1424 when the rotatable arm 1932 is in the locked position, i.e., the position shown in FIG. 22. The abutment surface 1944 may be substantially flat and planar parallel to an axis of rotation of the rotatable arm 1932 Thus, when the rotatable arm 1932 is in the locked position, a planar surface of the rotatable arm 1932 (i.e., abutment surface 1944) can contact a planar surface of the housing 1424 (i.e., on wall 1424a). The planar surfaces' contact can distribute pressure across a wide area (e.g., a large majority of the width of the rotatable arm 1932), thereby decreasing local stresses on the wall 1424a of the housing 1424 caused by the arm 1932 and thereby reducing any risk of damage due to contact with the arm 1932. Additionally, the surface 1944 can enable less rigid or durable materials to be used for the rotatable arm 1932 as compared to the thinner contact surfaces (on stops 1444) shape of arm 1432, such as, for example, plastics or composites, since the pressure of the arm 1932 is more distributed.

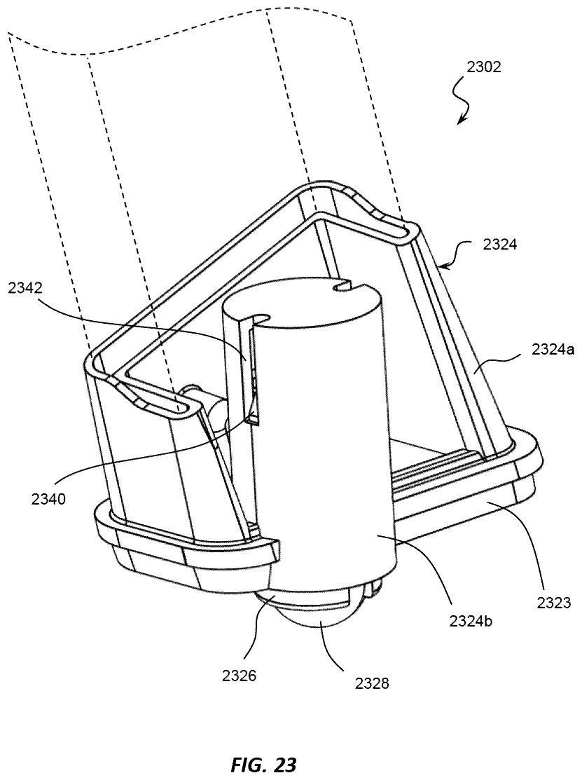

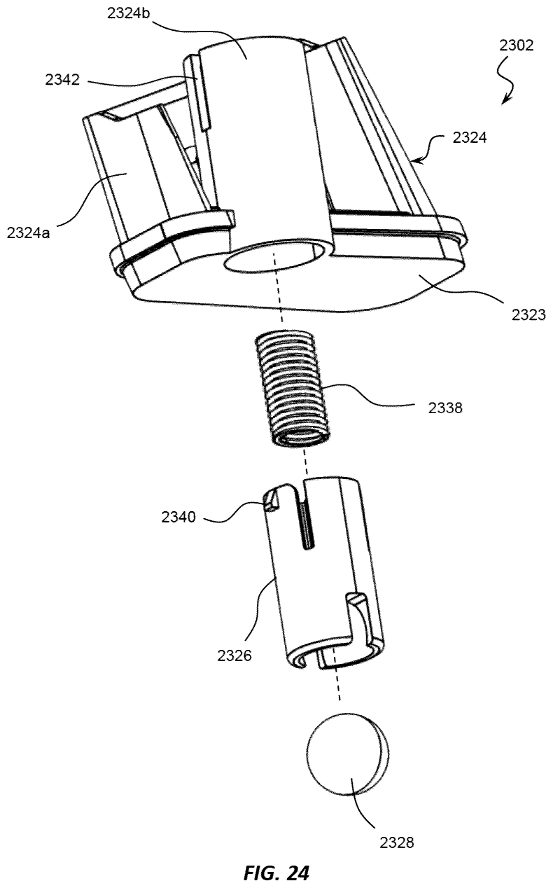

FIGS. 23-26 show another example embodiment of a roller assembly 2302 for a ladder. The roller assembly 2302 may be attachable with, or integrated into, bottom ends of various embodiments of ladders (e.g., 100, 900) and rails (e.g., 106, 116) described herein. The roller assembly 2302 can include a housing 2324 (including an upper housing 2321 and a lower housing 2323) having features common with the other housings described herein (e.g., housing 124). The housing 2324 may include a laterally outer housing portion 2324a and a laterally inner housing portion 2324b, and the laterally inner housing portion 2324b may enclose at least one biasing member 2328 and a carriage 2326 holding a roller 2328.

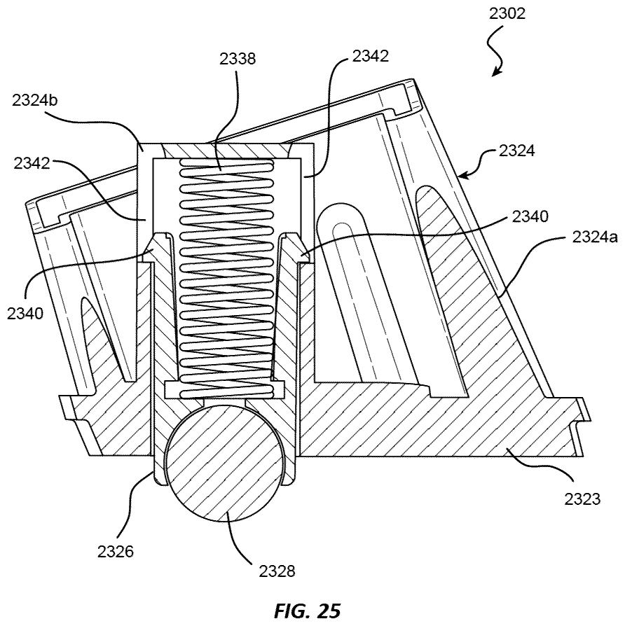

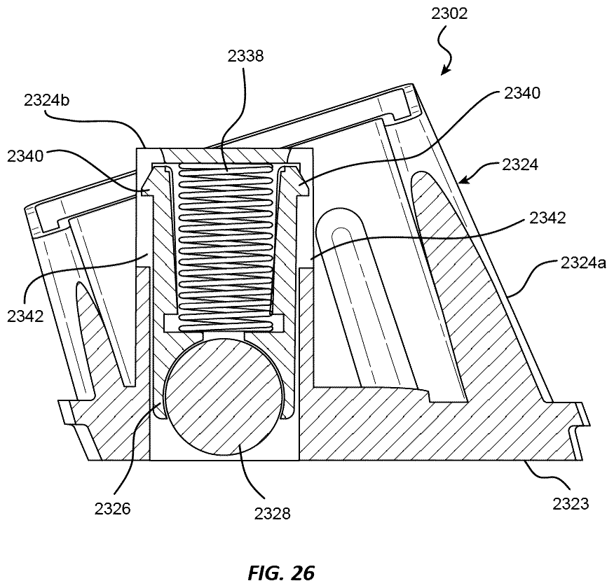

The carriage 2326 may comprise at least one (e.g., a pair) of lateral snap hooks 2340. The snap hooks 2340 can define a width slightly greater than the width or diameter of the opening at the bottom of the laterally inner housing portion 2324b. Thus, when the carriage 2326 is inserted into the bottom opening of the laterally inner housing portion 2324b, top ramped surfaces of the snap hooks 2340 urge the snap hooks 2340 radially inward (toward each other from opposite lateral sides of the carriage 2326) to allow the carriage 2326 to travel into the bottom opening. Upon reaching sufficient insertion depth, the snap hooks 2340 can laterally snap outward and into corresponding retaining slots 2342 in the sides of the laterally inner housing portion 2324b, as shown in FIGS. 23, 25, and 26. The downward-facing surfaces on the snap hooks 2340 may be parallel to the bottom surfaces of the slots 2342 and not ramped, so the snap hooks 2340 can “hook” the carriage 2326 to the housing 2424 to prevent withdrawal or extension of the carriage 2326 beyond a maximum extension displacement relative to the housing 2424, as shown in FIG. 25. However, the slots 2342 can have a length extending below the top end of the laterally inner housing portion 2324b to allow the carriage 2326 to move upward into the laterally inner housing portion 2324b before reaching a maximum inward displacement/retraction position that is raised relative to the maximum extended position, as shown in FIG. 26.

The roller 2328 can comprise a substantially spherical roller or ball configured to snap-fit into the bottom end of the carriage 2326. Once inserted, the bottom end of the carriage 2326 can surround the roller 2328 at a diameter slightly less than the maximum diameter of the roller 2328 in a manner preventing the roller 2328 from falling out of the carriage 2326 when not in contact with the ground. As with other embodiments disclosed herein, the biasing member 2328 can bias the carriage 2326 into the extended position (FIG. 25) so that the ladder to which the roller assembly 2302 is attached can roll on the roller 2328 across the ground or other support surface. The ball-shaped roller 2328 can slide within the carriage 2326 and roll in any direction, thereby granting the ladder additional degrees of freedom of movement as compared to embodiments employing a wheel (e.g., 140). The roller 2328 can therefore allow the ladder to laterally roll at the roller assembly 2302 toward a left or right direction relative to a user holding both rails in their hands and facing the front rungs. The roller 2328 can likewise enable rolling laterally toward a front or back direction relative to the user in that position. Accordingly, ball-shaped rollers 2328 can provide additional maneuverability to the rolling ladder in a manner similar to pivotable caster wheels but while doing so in a compact and simplified form.

When sufficient weight is applied to the ladder (e.g., to the rungs) to overcome the biasing force of the biasing member 2328, the carriage 2326 can retract with the roller 2328 to allow the lower housing 2323/lower portion of the housing 2324 to support the ladder instead of, or in addition to, the roller 2328. Thus, the roller 2328 can move to a retracted position while a user stands on the rungs, and the ladder may not roll during that time.

A locking mechanism, to hold the carriage 2326 in a retracted position even when weight is not applied to the ladder, is not shown in connection with roller assembly 2302. However, it will be understood by those having skill in the art and the benefit of the present disclosure that a lock member (e.g., a rotatable arm 132 and pivot pin 136) can be added to the roller assembly 2302, along with a flattened surface 133a, to enable retraction locking of the carriage 2326.

Various ladder embodiments can be made using features and principles disclosed herein for various roller assembly embodiments. For example, a ladder may be constructed using two roller assemblies 2302 on the rear rails (e.g., 116) and two roller assemblies 102 on the front rails (e.g., 106). In this manner, half of the feet of the ladder can roll along one axis of motion, due to the wheels of roller assemblies 102, and the other half can roll in any lateral direction, due to the rollers of roller assemblies 2302. Another embodiment may include wheels (e.g., 140) on all roller assemblies (e.g., as shown in ladder 100) for primary rolling maneuverability along one axis of motion (e.g., front and back directions only). Another embodiment may include spherical rollers (e.g., 2328) on all four feet to allow horizontal rolling in any direction at all four feet.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A ladder, comprising:
a pair of rails spaced apart from each other;
a set of rungs coupled to and extending between the pair of rails;
a roller assembly, comprising:
a carriage slidable relative to a rail of the pair of rails; and
a roller rotatably coupled to and movable with the carriage relative to the rail;
wherein the roller assembly is movable relative to the rail between a first position and a second position;
wherein in the first position, the roller extends below a bottom end of the rail;
wherein in the second position, the roller is retracted relative to the first position;
wherein the roller assembly is movable, in response to application of a downward force to a rung of the set of rungs, from the first position to the second position; and
a lock member movable between an unlocked position and a locked position, wherein in the unlocked position, the carriage is movable between the first position and the second position, and wherein in the locked position, the carriage is prevented from moving to the first position.

2. The ladder of claim 1, wherein the roller assembly further comprises at least one biasing member applying a force biasing the carriage from the first position toward the second position.

3. The ladder of claim 1, wherein the roller includes a wheel having an axle coupled to the carriage.

4. The ladder of claim 1, wherein the roller includes a sphere.

5. The ladder of claim 1, further comprising a foot body coupled to the bottom end of the rail, wherein the carriage is slidably coupled to the foot body.

6. The ladder of claim 5, wherein the foot body comprises a cavity, the carriage being slidable within the cavity.

7. The ladder of claim 6, wherein internal walls of the foot body encircle the carriage.

8. The ladder of claim 1, wherein the lock member includes a rotatable arm, wherein in response to rotation of the rotatable arm, the carriage moves from the first position to the second position.

9. The ladder of claim 8, wherein the rotatable arm includes a cam and a pivot pin extending from the cam, wherein in response to rotation of the cam, the pivot pin moves the carriage from the first position to the second position.

10. A foot for a ladder, the foot comprising:
a body attachable to a bottom end of a rail of a ladder, the body having a bottom surface;
a roller rotatable relative to the body and movable relative to the body between an extended position and a retracted position;
wherein when the roller is in the extended position, the roller extends below a bottom surface of the body;
wherein when the roller is in the retracted position, the roller is positioned at or above the bottom surface of the body;
a spring configured to apply a force to the roller, the force urging the roller from the retracted position toward the extended position.

11. The foot of claim 10, further comprising a lock arm operable to lock the roller at or above the retracted position relative to the body.

12. The foot of claim 10, wherein the body comprises a laterally inner side, wherein the roller is positioned on the inner side of the body.

13. The foot of claim 10, wherein the body comprises an upper body and a lower body, wherein the bottom surface is positioned on the lower body, wherein the lower body comprises a first material more resiliently flexible than a second material of upper body.

14. The foot of claim 10, wherein the body is configured to attach to the bottom end of the rail at a non-orthogonal angle relative to the bottom surface.

15. The foot of claim 14, wherein the body comprises a front toe, wherein when the roller is in the extended position, the roller is positioned above a plane, the plane being orthogonal to the non-orthogonal angle and intersecting the front toe.

16. The foot of claim 10, wherein the roller comprises a roller member and a carriage member, the roller member being rotatable relative to the carriage member, the carriage member being slidably coupled to the body.

17. A ladder assembly, comprising:
a first assembly including:
a first pair of rails spaced apart from each other;
a first set of horizontal members extending between and coupled to the first pair of rails;
a second assembly including:
a second pair of rails spaced apart from each other, the second pair of rails being rotatably coupled with the first pair of rails;
a second set of horizontal members extending between and coupled to the second pair of rails;
a pair of roller assemblies positioned at respective bottom ends of the first pair of rails, each roller assembly of the pair of roller assemblies including:
a wheel;
a biasing member; and
a locking member,
wherein the wheel is biased away from the respective bottom end by the biasing member to an extended position;
wherein, in response to application of a downward force to the first assembly or to the second assembly, the wheel is retractable to or above the bottom end to a retracted position; and
wherein the locking member is configured to lock and unlock the wheel in the retracted position.

18. The ladder assembly of claim 17, wherein the locking member is rotatable between a first position locking the wheel in the retracted position and a second position permitting movement of the wheel to the extended position.

19. The ladder assembly of claim 17, wherein the pair of roller assemblies comprises at least one housing, wherein when the wheel is in the retracted position, the wheel is laterally covered by the at least one housing.

20. The ladder assembly of claim 17, wherein, in response to rotation of the locking member, the wheel translates relative to the bottom end.
